(19) United States
(12) Patent Application Publication
(10) Pub. No.: US 2009/0285069 A1
(43) Pub. Date: Nov. 19, 2009

(54) FILE PROTECTION METHOD USED IN SOLID STATE DISC ARRAY SYSTEM

(76) Inventors: Chih-Yi YANG, Taipei City (TW); Hui-Hsuan WU, Taipei City (TW)

Correspondence Address: HDLS Patent & Trademark Services, P.O. BOX 220746, CHANTILLY, VA, 20153-0746, US

(21) Appl. No.: 12/432,920

(22) Filed: Apr. 30, 2009

(30) Foreign Application Priority Data
May 15, 2008 (TW) 097117870

(51) Int. Cl. G11B 19/04

(52) U.S. Cl. 369/53.21; G9B/19.005

(57) ABSTRACT

A file protection method is used for preventing files stored in a solid state disc array system from being reproduced unauthorizedly. After a file is produced completely, it is stored in a solid state disc array system connected to an external computer. When the external computer is to execute the files stored in the solid state disc array system, it checks the files and parameters (e.g. key password or serial number) set in the solid state disc array system step by step. Only when all of the parameters are correct and correspond to one another, the files can be executed normally. In this way, the files can be protected from being copied unauthorizedly.

### BACKGROUND OF THE INVENTION

1. Field of the Invention

The present invention relates to a file protection method, and in particular to a file protection method used in a solid state disc array system.

2. Description of Prior Art

With the rising advancement of modern computer technology, the computer has become a necessary element in the twenty-first century and the key to promote the operations of industry and commerce.

Since the semiconductor process is well-developed recently, the performance of computer hardware is increased while its price is reduced. Therefore, many people can afford to buy and use a personal computer equipped with a high-performance processor. Most application software that was only used in large industrial computers previously has been modified for home usage, which facilitates the daily life of customers greatly. Further, with the mature development of computer hardware technology, game software executed in a computer interface has been developed to rival a TV game. Thus, many game players like to buy game software, so that the sales volume of the game software is increased gradually.

The existing storage medium for the circulation and sale of computer software is optical discs. With the spread of disc burners and the convenience of Internet, the pirated edition has become a threat to the original edition of computer software. The pirated edition of computer software is produced by means of copying the hard disc of a personal computer directly, and is spread via the Internet. Furthermore, the pirated edition of computer software can be made into a video file that is executed by a virtual optical disk driver or reproduced by means of a disc burner. All of the above-mentioned pirating actions substantially infringe the intellectual property right of the inventor of software. Thus, people all over the world who work in the field of computer invest a lot of time and money to protect the copyright and commercial value of the software continuously.

Recently, many manufacturers propose a plurality of technologies to overcome the issue resulting from the pirated editions. For example, most software companies like to use “SafeDisc” invented by Macrovision Co., “SecuRom” invented by Sony Co. and the anti-copy technology involved in game software (such as “StarForce”).

All of the above-mentioned methods belong to an anti-copy technique on an optical disc. However, the optical disc is read by an associated optical disc driver of a mechanical construction, in which a pickup head moves linearly. Together with the rotation of optical disc, the pickup head can store and read the data at different locations on the optical disc, which, however, takes more time and the operation of mechanical components will generate a great amount of heat inevitably. On the other hand, since the density of data stored in the optical disc is increased, the vibration-damping effect of the optical disc is deteriorated.

The above is the drawback in using optical discs and optical disc drivers. Thus, when using a digital storage medium of non-volatile memory (such as a flash disc and solid state disc), owing to its fast processing speed, low heat generation rate, high vibration resistance and the like, such a digital storage medium has replaced the optical disc gradually to become a novel and popular data storage medium. However, the application software available in the market now is still primarily stored in optical discs because there is still no feasible and effective method for protecting the files stored in the digital storage medium from being copied without authorization.

### SUMMARY OF THE INVENTION

The present invention is to provide a file protection method used in a solid state disc array system, thereby protecting the files stored in a disc array system consisted of a plurality of solid state memory sub-systems. In this way, the files can be protected from being reproduced and used without authorization.

According to the present invention, after a file is produced completely, it is stored in a solid state disc array system connected to an external computer. When the external computer is to execute the files stored in the solid state disc array system, it checks the files and parameters set in the solid state disc array system step by step. Only when all of the parameters are correct and correspond to one another, the files can be executed normally.

### BRIEF DESCRIPTION OF THE DRAWINGS

FIG. 1 is a schematic view showing the basic construction of the present invention;

FIG. 2 is a flow chart showing the setting process of a preferred embodiment of the present invention; and

FIG. 3 is a flow chart showing the protecting process of a preferred embodiment of the present invention.

### DETAILED DESCRIPTION OF THE INVENTION

The characteristics and technical contents of the present invention will be explained with reference to the accompanying drawings. However, the drawings are illustrative only but not used to limit the present invention.

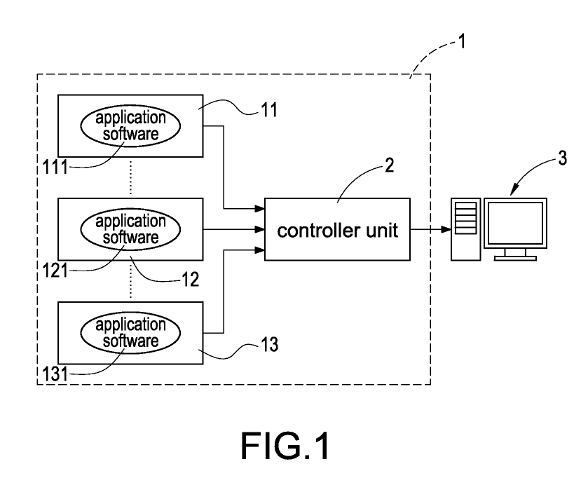

Please refer to FIG. 1, which is a schematic view showing the basic construction of the present invention. The file protection method of the present invention is mainly applied to a solid state disc array system 1 constituted of a plurality of solid state memory sub-systems 11˜13. The plurality of memory sub-systems 11˜13 is constituted of a plurality of non-volatile memories such as flash memories. A file such as the application software 111˜131 sold by a software company is stored in the plurality of memory sub-systems 11˜13. The plurality of memory sub-systems 11˜13 is connected to a controller unit 2. The plurality of memory sub-systems 11˜13 and the application software 111˜131 stored therein are decoded and integrated by the controller unit 2 so as to form a disc array system 1. Then, the disc array system 1 is connected to an external computer 3, so that the computer 3 can execute the application software 111˜131 on the disc array system 1.

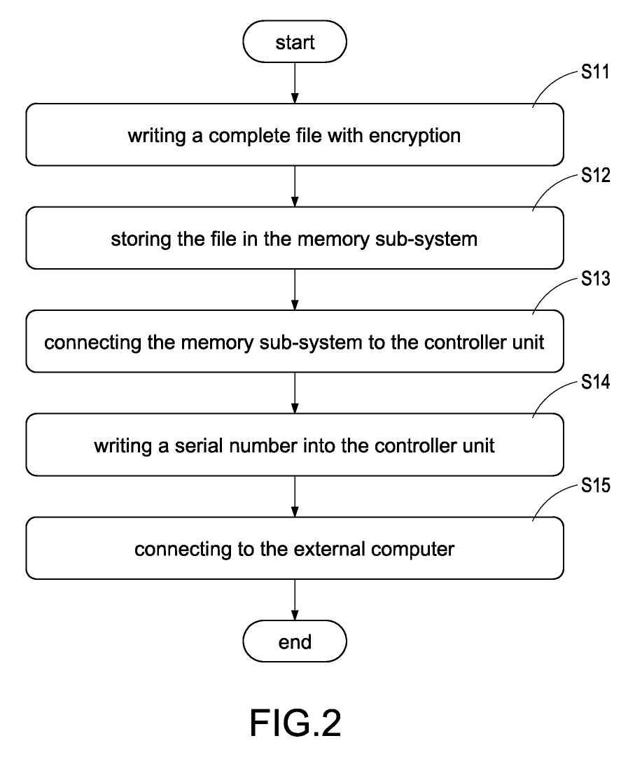

Next, please refer to FIG. 2, which is a flow chart showing the setting process of a preferred embodiment of the present invention. In this figure, the memory sub-system 11 and the application software 111 are described for illustration. First, the application software 111 is written completely with a key password set therein (S11). Then, the application software 111 is stored in the solid state memory sub-system 11 (S12). Then, the memory sub-system 11 is connected to a controller unit 2 to form a disc array system 1 (S13). After the step S13 is performed completely, the memory sub-system 11 is made with a specific serial number written in the controller unit 2, so that the disc array system 1 can lock the memory sub-system 11 (S14). Finally, the disc array system 1 is connected to the external computer 3 executing the software 111 (S15).

In addition, when the controller unit 2 is manufactured completely, it has a unique serial number. Therefore, the application software 111 can cooperate with a fixed solid state memory sub-system 11 and a fixed controller unit 2. If the software 111 is reproduced without authorization to be used in other memory sub-system or controller unit with different serial number, it cannot pass the check and thus the execution of software is not permitted.

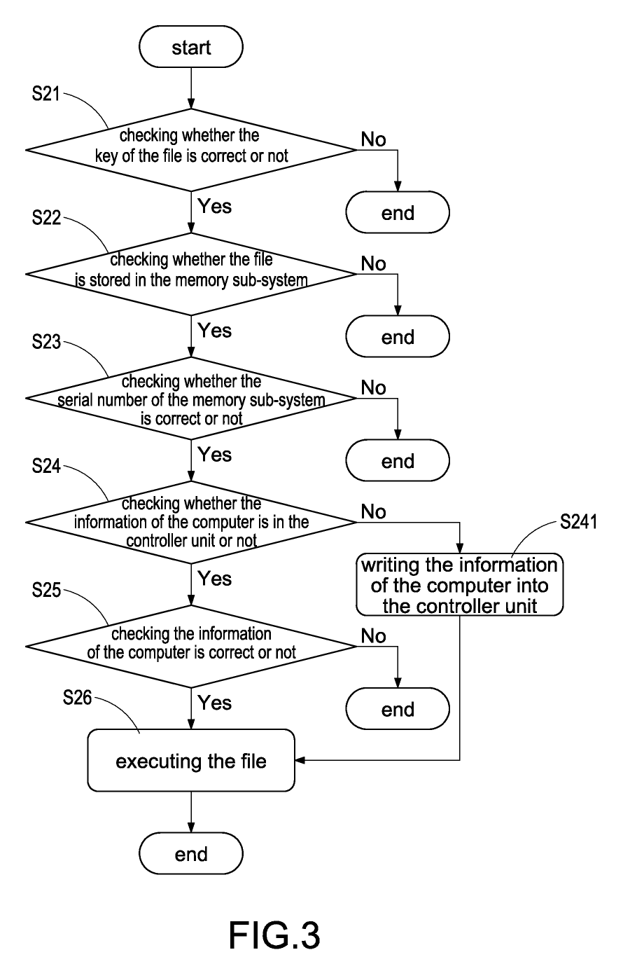

Next, please refer to FIG. 3, which is a flow chart showing the protecting process of a preferred embodiment of the present invention. When the external computer 3 is to execute the application software 111, it has to check whether the key password of the application software 111 is correct or not (S21). If the key password of the software 111 is not correct, the execution of the software 111 is stopped. Then, the procedure proceeds to check whether the application software 111 is stored in a memory sub-system (S22). If the software 111 really exits in a memory sub-system, the procedure proceeds to check whether the inherent special serial number of the memory sub-system 11 for storing the application software 111 coincides with the serial number password stored in the controller unit 2 (S13). If the serial number of the memory sub-system 11 does not coincide with the serial number identified by the controller unit 2, the memory sub-system 11 will be identified as not the original storage medium for the software 111. As a result, the software 111 cannot be executed.

Furthermore, if the external computer 3 finds that the memory sub-system does not exist when executing the check of the software 111, this means the application software 111 is not stored in a memory sub-system. Thus, the software may be reproduced without authorization and spread via Internet or other ways. Thus, the execution of the software will not be permitted either.

Finally, the procedure checks whether the information of the external computer 3 is recorded in the controller unit 2 or not (S24). The information is, for example, the serial number of a central processing unit (CPU), but it is not limited thereto. If the controller unit 2 is not recorded with any other information relating to the external computer 3, it means the application software 111 is executed at first time. In order to check the execution of the software at next time, the information of the external computer 3 is written back into the controller unit 2 (S241), and then the application software 111 is executed (S26).

If any information relating to a computer is in the controller unit 2, it is necessary to identify whether the information confirms to that of the external computer 3 connected to the disc array system 1 (S25). If yes, the external computer 3 can execute the software 111 directly on the disc array system (S26).

If it is found that the information of the external computer 3 for executing the software 111 is different from the serial number recorded in the controller unit 2, the execution of software is not permitted. In this way, the software 111 can be protected more carefully. Furthermore, the unauthorized action that the software is executed in a plurality of computers can be prevented.

After the above-mentioned check procedure is completed and confirmed without any errors, the external computer 3 can read the application software 111 and decode the software 111 via the controller unit 2. Finally, the external computer 3 can execute the application software 111 directly on the solid state disc array system.

Incidentally, with the rapid development of current semiconductor technology, various kinds of hardware will be weeded out and changed very fast. Thus, the file protection method of the present invention also considers the associated procedure for upgrading and updating hardware. As mentioned in the above, the disc array system to which the method of the present invention is applied is constituted of a plurality of solid state memory sub-systems and a controller unit. Each of the solid state memory sub-system is constituted of a plurality of non-volatile memories. However, in a step of the file protection method of the present invention, a specific serial number inherent in the solid state memory sub-system has to be identified to pass the check, whereby the application software stored therein can be executed. Thus, when the individual solid state memory sub-system of a disc array system is to be upgraded or weeded out, or the non-volatile memories of each solid state memory sub-system are to be exchanged, the serial number after the upgrade or exchange has to be registered again for checking the execution of the software.

The above description is used to explain a preferred embodiment of the present invention, but not used to restrict the scope of the present invention. Equivalent modifications can be still made without departing from the spirit and scope of the present invention. Thus, all such modifications are embraced in the appended claims.

What is claimed is:

1. A file protection method used in a solid state disc array system, the solid state disc array system being constituted of a plurality of solid state memory sub-systems and a controller unit, the file being stored in the plurality of solid state disc memory sub-systems, the method comprising the steps of:
a) connecting the solid state disc array system to an external computer;
b) checking whether the file conforms to a preset condition or not;
c) checking whether the solid state memory sub-system conforms to a preset condition or not;
d) checking whether the external computer conforms to a preset condition or not;
e) executing the file only after the conditions of the steps b), c), d) are all conformed.

2. The file protection method according to claim 1, wherein the preset condition of the step a) is conformed when a key password of the file is correct.

3. The file protection method according to claim 1, wherein the preset condition of the step b) is a serial number of the solid state memory sub-system coincides with a serial number recorded in the controller unit.

4. The file protection method according to claim 1, wherein the condition of the step c) is the information of the external computer coincides with the information recorded in the controller unit.

5. The file protection method according to claim 4, wherein the information of the external computer is a serial number of a central processing unit (CPU).

6. The file protection method according to claim 5, wherein if the information of the external computer is not recorded in the controller unit, a step f) is performed to record the information of the external computer in the controller unit.
